(19) United States
(12) Patent Application Publication
(10) Pub. No.: US 2009/0241843 A1
(43) Pub. Date: Oct. 1, 2009

(54) PET FEEDING CONTAINMENT SYSTEM

(75) Inventors: Fernando Becattini, JR., Malvern, PA (US); Fernando Becattini, SR., Devon, PA (US)

Correspondence Address: RATNERPRESTIA, P.O. BOX 980, VALLEY FORGE, PA, 19482, US

(73) Assignee: Fernando Becattini, JR., Malvern, PA (US)

(21) Appl. No.: 12/060,641

(22) Filed: Apr. 1, 2008

(51) Int. Cl. A01K 1/10; A01K 15/04

(52) U.S. Cl. 119/51.5; 119/61.5; 119/61.56; 119/52.1; 119/63

(57) ABSTRACT

A pet feeding containment system adapted to hold food and water bowls comprises a base with at least one wall defining an interior space. The front section comprises a low portion and at least one high portion. The low portion provides a pet with access to food and water bowls, while the close proximity of the high portion to the pet's head and shoulders deters the pet from moving its head outside of the containment system while feeding. The containment system inhibits spills and contains those that occur, thus minimizing messes outside of the system. Another embodiment uses a filtering tray which is disposed above the base. The filtering tray has interstitial spaces that are sufficiently small to retain spilled food on the filtering tray but allow spilled water to pass through onto the base, thus enabling a pet owner to collect and re-use spilled food.

### FIELD OF THE INVENTION

The present invention pertains to pet feeding systems and particularly to the containment of pet food and water within such systems.

### BACKGROUND OF THE INVENTION

Household pets, particularly dogs and cats, are notorious for creating messes around their feeding area. Pets often knock food and water out of their bowls onto the surrounding floor and walls, or they spill and splash food and water onto the floor and surrounding area while feeding. Pet owners also create spills around pet feeding areas by accidentally bumping the feeding bowls or by spilling food and water while setting bowls on the floor. In some instances, spilled water saturates spilled food to create a soggy mess that is even more burdensome to clean. Pet owners are continually faced with the time-consuming task of cleaning the area surrounding their pets' feeding bowls.

Efforts have been made to minimize the messes around a pet's feeding area. For example, in U.S. Design Pat. No. 259,669, feeding bowls are attached to a floor mat so that spilled food and water lands on the mat, rather than on the surrounding floor. While this type of mat decreases the amount of spillage that lands on the floor, the unsightly mess surrounding the bowls remains exposed. An additional drawback is that when a pet stands on the mat, spilled matter laying on the mat can adhere to the pet's paws or feet and be tracked around the house, thereby widening the area that a pet owner needs to clean. Furthermore, it is unlikely that a mat can contain the spill of all of the contents of an overturned water or food bowl.

Other proposals provide a housing for the feeding bowls, together with an opening through which the pet gains access to the food. For example, U.S. Pat. No. 4,029,051 discloses a pet feeding and protective apparatus that is primarily directed at preventing larger animals from taking the food of smaller animals. According to the '051 patent, a feeding dish sits inside a housing that is enclosed; by side walls and a removable lid. An opening is provided in a side wall so that the pet can access the dish. One drawback to this type of device is that the only way for the pet to access the bowl is to place its head through an opening. Limited access through an opening is not conducive for a pet that requires space above its head so that it can lift its head while feeding. It is possible that the limited access, and resulting restrictions on the pet's movement, could encourage a pet to bring its food outside of the enclosure, thereby increasing the likelihood that dropped food will fall onto the surrounding floor area. Accordingly, it is desirable to provide pets with a conducive feeding environment that deters the pet from looking around while feeding, but still enables the pet to comfortably lift its head and eat in an open natural manner.

Other pet feeding assemblies aid in catching spills by providing an underlying container. For example, in U.S. Pat. No. 4,532,891, feeding bowls are engaged with a lattice member, which permits spilled food and water to fall though interstices into a collection pan. One of the shortcomings of such underlying containers is that spilled water and spilled food are collected together in the collection pan, causing the food to become soggy. Upon drying, the material hardens and adheres to the container surface and becomes more difficult to clean. This also prevents the pet owner from being able to collect the spilled food for re-use. In addition, feeding devices with underlying containers do not prevent food or water from splashing onto the surrounding floor or walls if the entire assembly is bumped by the owner or pet. Accordingly, it is desirable to utilize a pet feeding assembly that catches spills, but also keeps spills confined when the entire bowl is knocked over by a pet or an owner.

### SUMMARY OF THE INVENTION

The present invention provides a pet feeding system for containing the food and water of pets. The pet feeding containment system comprises a base with at least one wall that defines an interior space. The system is adapted to hold at least one bowl for containing food, water, or both. In an alternative embodiment, the base defines molds for receiving removable bowls.

According to an embodiment of the present invention, the containment system has one wall or multiple walls, with the walls having a low portion and at least one high portion. The front section of this embodiment comprises the low portion and at least one high portion. The low portion allows a pet to have access to food and water bowls. High portions of the remaining section and front section deter a pet from moving its head outside of the containment system while feeding, yet without obstructing the pet's path to the food and its ability to raise its head as desired while feeding. The base and walls of the containment system reduce the likelihood of spills and splashes caused by pets and owners and contain those that do occur.

According to another embodiment of the present invention, the pet feeding containment system includes a filtering tray disposed above the base and adapted to have food and water bowls resting on or abutting it. The filtering tray has interstitial spaces that are sufficiently small so that spilled food remains on top of the filtering tray but spilled water passes through the interstitial spaces onto the base. In an alternative embodiment, the filtering tray fits around molds in the base that are adapted to receive removable bowls. The filtering tray thus separates spilled food from spilled water and enables a user to collect and re-use the spilled food.

It is to be understood that both the foregoing general description and the following detailed description are exemplary, but not restrictive, of the invention.

### BRIEF DESCRIPTION OF THE DRAWINGS

The invention is best understood from the following detailed description when read in connection with the accompanying drawings, in which similar elements among the embodiments have reference numerals ending with the same digits. It is emphasized that, according to common practice, the various features of the drawings are not to scale. Included in the drawings are the following figures:

FIG. 1 illustrates a perspective view of an embodiment of the present invention;

FIG. 2 illustrates a top plan view of the embodiment of the present invention shown in FIG. 1;

FIG. 3 illustrates a cross-sectional view, along the line 3-3, of the embodiment of the present invention shown in FIG. 1;

FIG. 4 illustrates a perspective view of an embodiment of the present invention having the shape of a modified oval;

FIG. 5 illustrates a top plan view of the embodiment of the present invention shown in FIG. 4 having the shape of a modified oval;

FIG. 6 illustrates a perspective view of an embodiment of the present invention having a filtering tray;

FIG. 7 illustrates a rotated perspective view of the present invention shown in FIG. 6 having a filtering tray;

FIG. 8 illustrates a top plan view of the embodiment of the present invention shown in FIG. 6 having a filtering tray;

FIG. 9 illustrates a cross-sectional view, along the line 9-9, of the embodiment of the present invention shown in FIG. 6 having a filtering tray;

FIG. 10 illustrates an exploded view of an embodiment of the present invention having a filtering tray and a liner;

FIG. 11 illustrates a cross-sectional view of an embodiment of the present invention having a filtering tray and a liner;

FIG. 12 illustrates a perspective view of an embodiment of the filtering tray;

FIG. 13 illustrates a bottom perspective view of the embodiment of the filtering tray shown in FIG. 12;

FIG. 14 illustrates a perspective view of an embodiment of the present invention having a double wall;

FIG. 15 illustrates a cross-sectional view, along the line 15-15, of the embodiment of the present invention shown in FIG. 14 having a double wall;

FIG. 16 illustrates a cross-sectional view of a monolithic embodiment of the present invention having a double wall and a base defining at least one mold;

FIG. 17 illustrates a perspective view of an embodiment of the filtering tray having openings to fit around molds, such as the mold shown in FIG. 16;

FIG. 18 illustrates a cross-sectional view of a monolithic embodiment of the present invention having a base defining at least one mold and a filtering tray;

FIG. 19 illustrates an exploded view of an embodiment of the present invention having a lid;

FIG. 20 illustrates a perspective view of an embodiment of the present invention having a food container and a water container;

FIG. 21 illustrates a perspective view of several embodiments of the present invention having a rolled edge stacked on top of each other;

FIG. 22 illustrates a perspective view of several embodiments of the present invention having a double wall stacked on top of each other;

FIG. 23 illustrates a cross-sectional view of an embodiment of the present invention having protruding mounts as means to elevate feeding bowls;

FIG. 24 illustrates a perspective view of an embodiment of the present invention having a modified oval shape, a double wall, and a raised interior base surface as means to elevate feeding bowls; and

FIG. 25 illustrates a cross-sectional view, along the line 25-25, of the embodiment of the present invention shown in FIG. 24.

### DETAILED DESCRIPTION OF THE INVENTION

The present invention is directed to a pet feeding system adapted to contain the food and water of pets. While the pet feeding containment system has principally been illustrated in the figures as having one bowl for containing food and one bowl for containing water, the invention contemplates a pet feeding containment system having no bowl, as well as a system that has one bowl, or two or more bowls. As used throughout, the term “bowl” includes any bowl which is adapted to contain either food or water, or both food and water, in the latter case having a divider to separate the food and water. The pet feeding containment system is intended to be used by one or multiple pets. Any suitable material may be used for the features of the present invention. Preferably, the features of the pet feeding containment system are made of any impervious material, most preferably a material that is impervious to liquids.

Although the pet feeding containment system is predominantly illustrated in the figures as having four walls and a substantially rectangular shape, a system having only one wall or any number of multiple walls is also contemplated. The single wall or multiple walls are further contemplated as having a variety of alternative shapes, including, for example, curved, rounded, or straight walls. It is also contemplated that the alternative shapes of the walls bring about alternative shapes of the containment system, including, for example, an oval, circle, pentagon, square, rectangle, or modified oval with flattened sides, among others. It should be further appreciated that various features of the containment system described below are contemplated as having a variety of alternative shapes, preferably shapes that correspond to the shapes of the walls and overall shape of the containment system. For example, a circular containment system preferably includes a circular filtering tray and a circular liner, as these features are described below.

The single wall or multiple walls of the system comprise a front section and a remaining section. The front section comprises a low portion and at least one high portion. The remaining section comprises a high portion. As used herein, the low portion is that portion of the front section of the at least one wall which has the lowest absolute height, i.e. absolute height being measured from the floor upon which the system rests. Moreover, the high portion is a portion of the at least one wall which has an absolute height that is greater than that of the low portion.

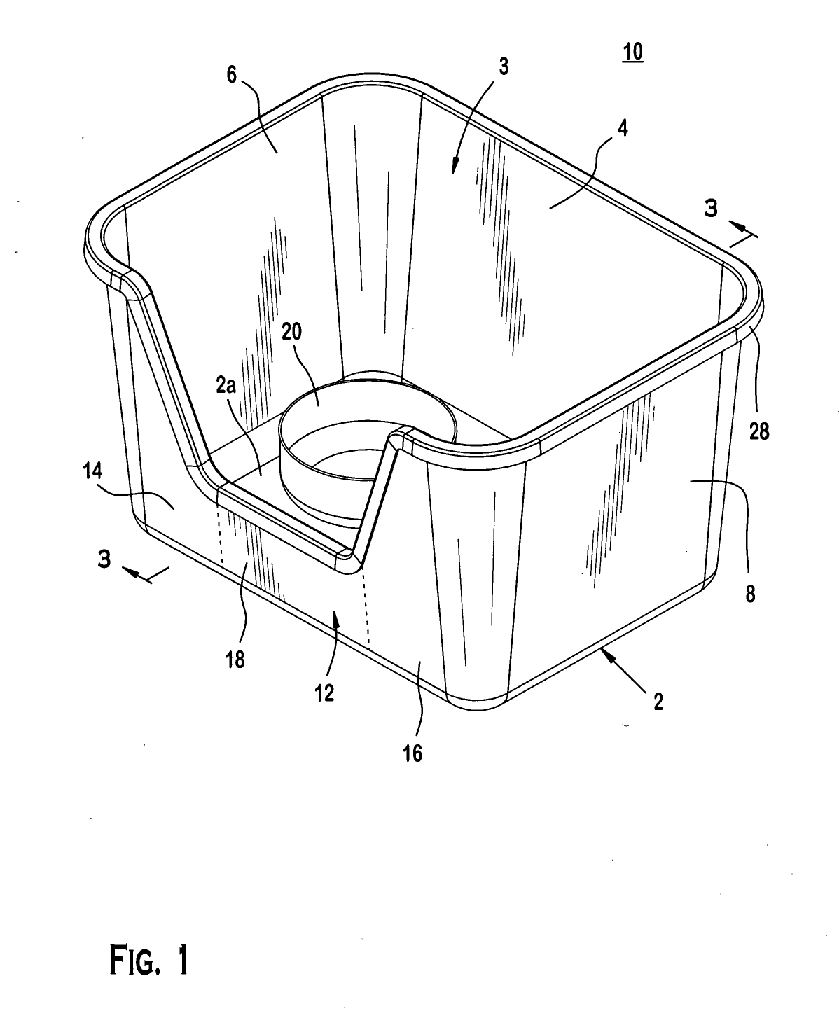

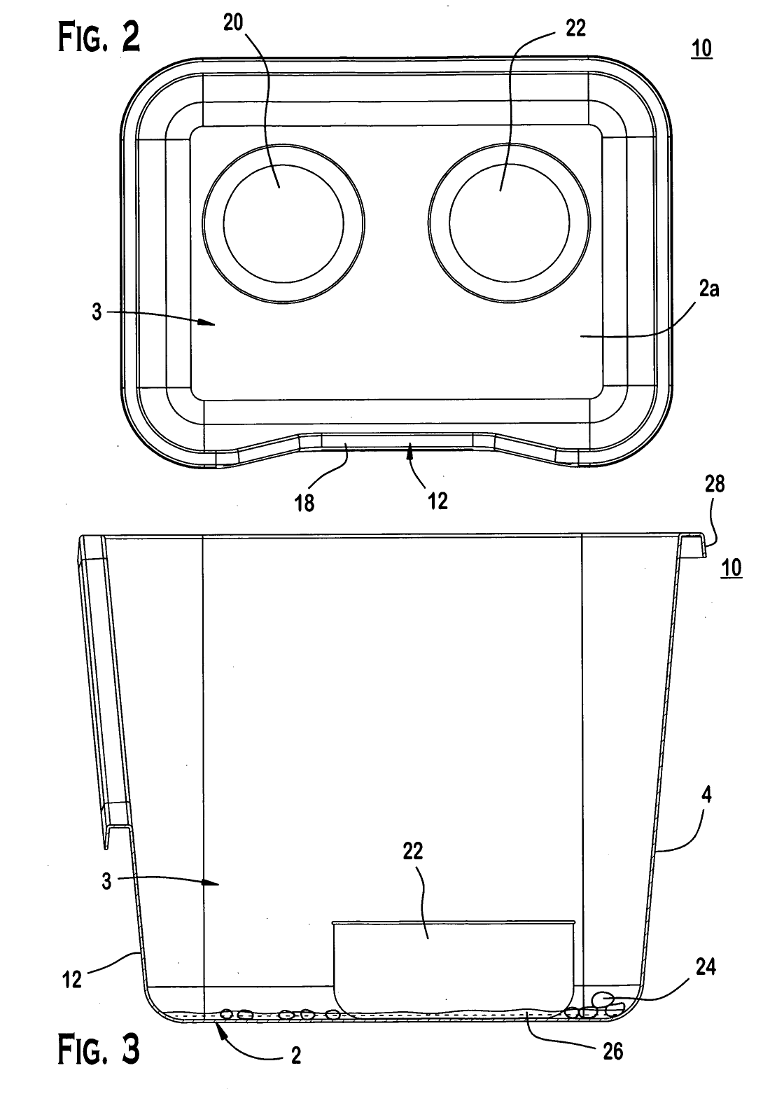

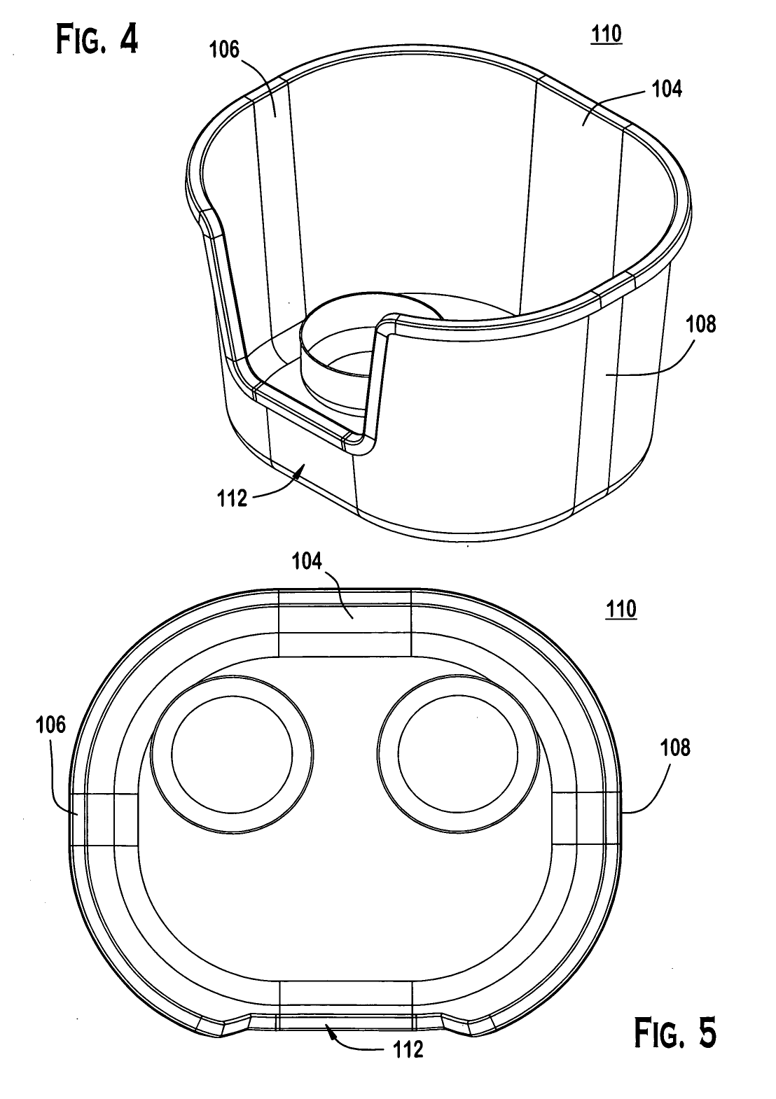

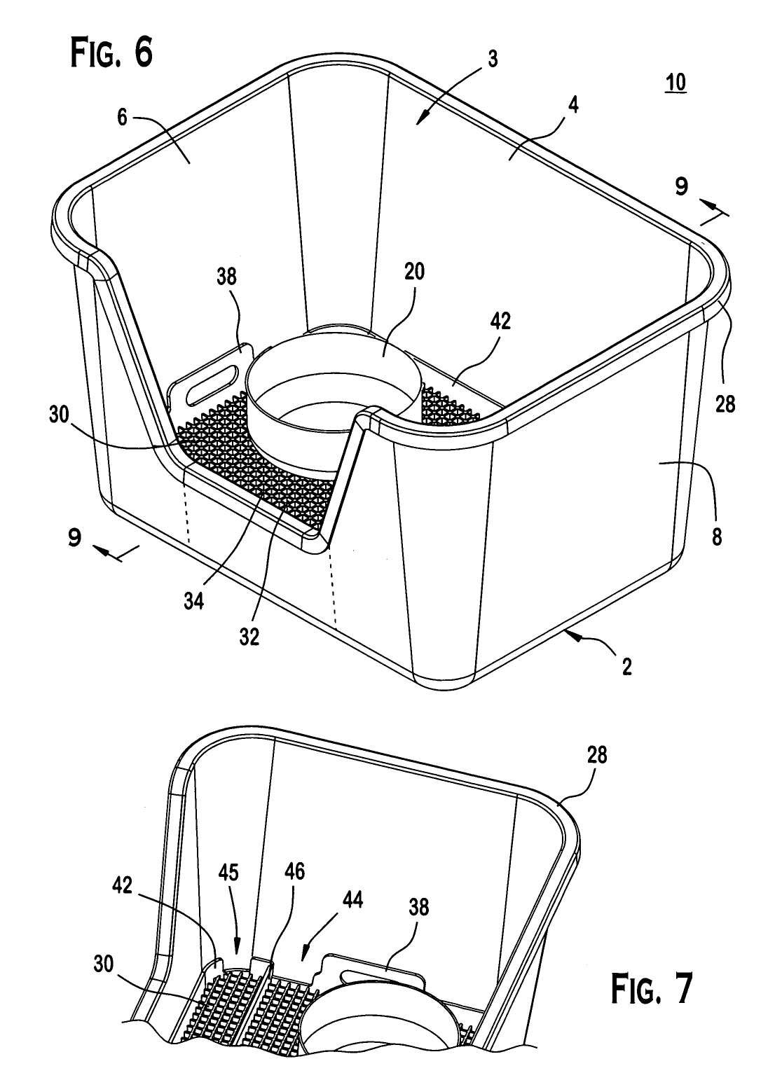

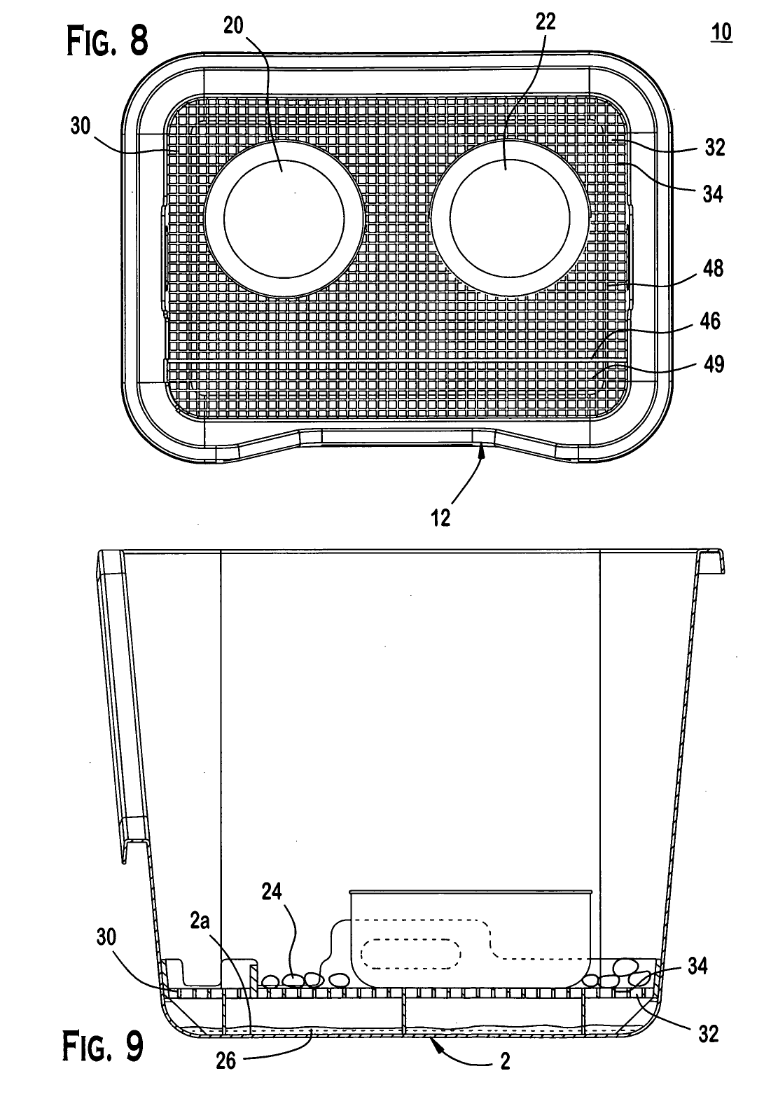

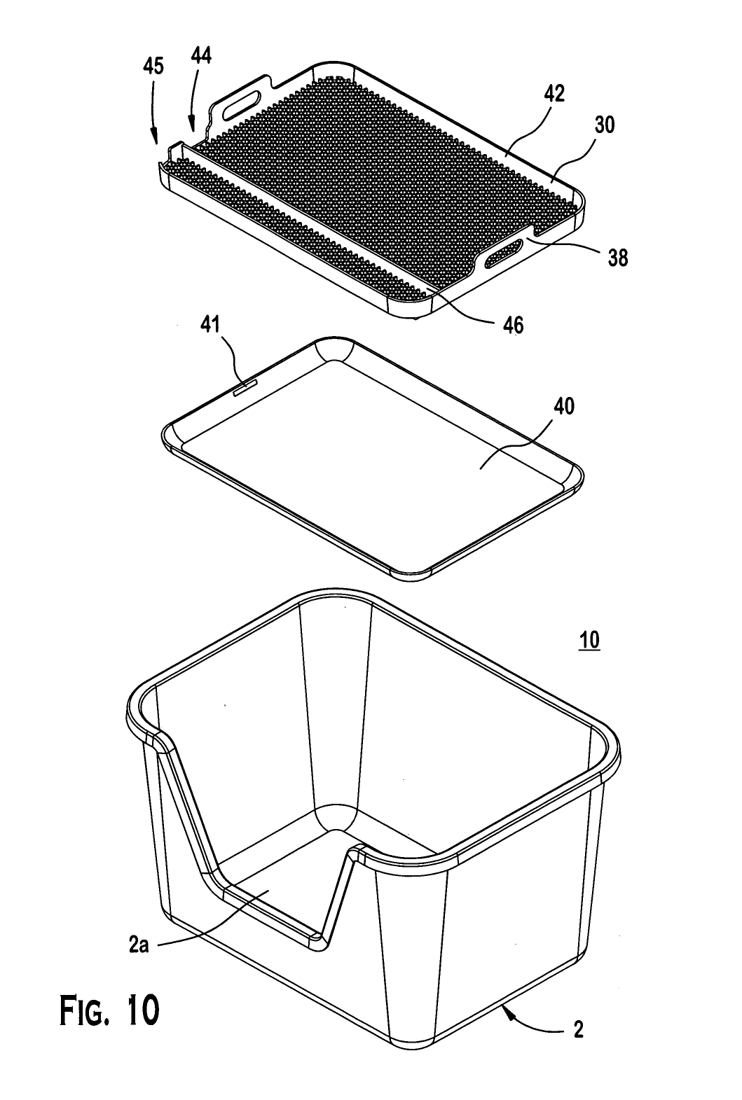

As used throughout, and except where specifically stated otherwise, the height of the high portions is measured from the floor upon which the containment system rests, and the height of the low portion is measured from the surface upon which the feeding bowls rest or are adapted to rest, whether that surface is the interior base surface 2a (as shown in FIGS. 1 and 2) or a filtering tray 30 (as shown in FIG. 9). The low portion has a height that is lower than the height of the high portions and is of sufficient height to contain all or substantially all of the contents of the bowls in the event of a spill. For example, the height of the low portion may have a height of about two inches in order to sufficiently contain the spills from a small bowl, or alternatively a height of about six inches may be needed to sufficiently contain the spills of a larger bowl.

In reference to the drawings, FIG. 1 is a perspective view of an embodiment of the invention. A pet feeding containment system 10 according to FIG. 1 comprises a base 2 with four walls extending upwardly from base 2 and defining an interior space 3. Base 2 includes an interior base surface 2a, as shown, for example, in FIGS. 1 and 2. The four walls comprise a front section 12 and a remaining section. The at least one high portion of the front section 12 comprises a left portion 14 and a right portion 16. The low portion of the front section 12 comprises a middle portion 18. The remaining section comprises a rear wall 4, a first side wall 6, and a second side wall 8. Preferably, the four walls extend from a periphery of the base 2. However, in an alternative embodiment, the base 2 is expanded outside of the walls so that the walls do not extend from the base 2 at the periphery.

The high portions of the embodiment in FIG. 1 include the rear wall 4, the first side wall 6, the second side wall 8, the left portion 14 of the front section 12, and the right portion 16 of the front section 12. The low portion of the embodiment in FIG. 1 comprises the middle portion 18 of the front section 12. The left portion 14 is connected to the first side wall 6 and the right portion 16 is connected to the second side wall 8. The height of the left portion 14 decreases at a slope of 90 degrees or less from the left portion 14 to the middle portion 18, and the height of the right portion 16 decreases at a slope of 90 degrees or less from the right portion 16 to the middle portion 18. The embodiments in the figures have principally been illustrated to show the high portions decreasing at an angle to the low portion. However, it is contemplated in other embodiments that the high portions decrease substantially straight down to the low portion. The low portion enables the pet to reach into the interior space from above and to access the feeding bowls. The pet is not restricted from lifting its head while eating or drinking because of the open space above, which creates a conducive feeding environment for the pet.

FIG. 4 shows a preferred shape of the invention, in which the corners of the pet feeding containment system 110 are substantially curved, forming, in effect, a flattened oval. The at least one wall comprises a rear section 104, two side sections comprising a first side section 106 and a second side section 108, and a front region 112, all of which are substantially flat. The curved corners permit the pet feeding containment system 110 to take up less floor space, and to require less material to fabricate, than a substantially rectangular embodiment. The flat sections allow the pet feeding containment system 110 to be more flush with any surrounding walls, as opposed to a true oval or circle. It is also contemplated that a containment system 110 in the shape of a modified oval is less cumbersome to clean than a substantially rectangular embodiment, and may be considered more aesthetically pleasing.

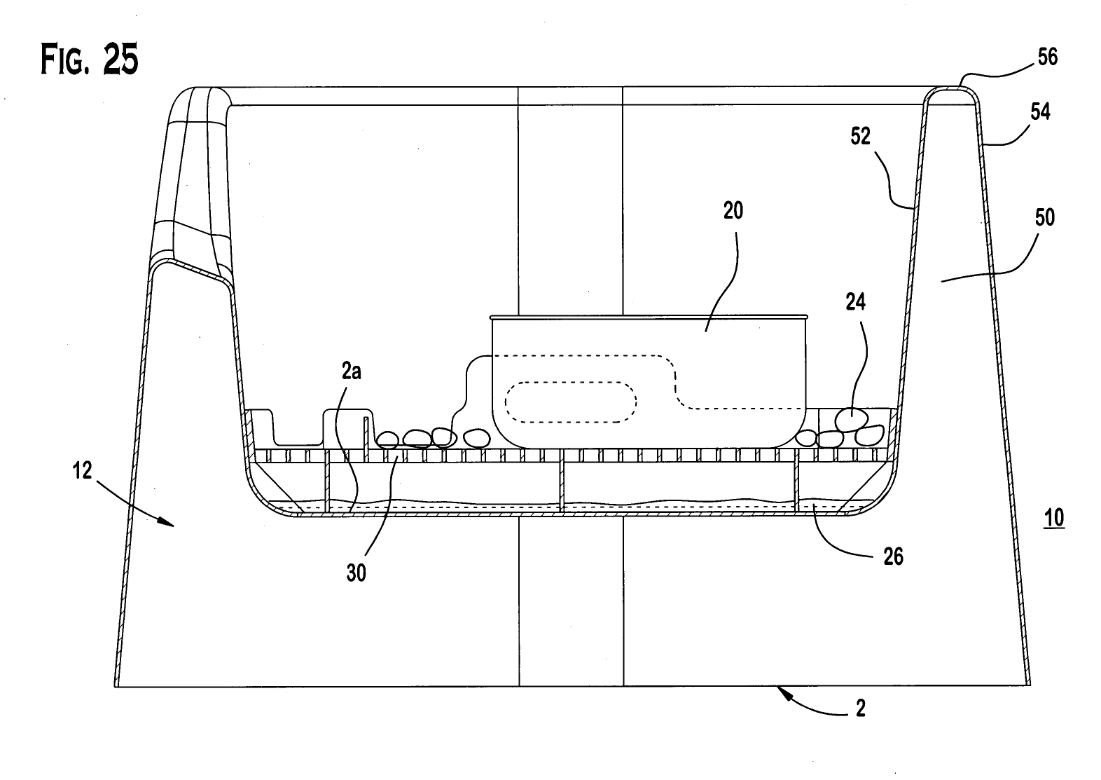

As discussed previously, and as used throughout, except where specifically stated otherwise, the height of the high portions is measured from the floor upon which the containment system 10 rests, and the height of the low portion is measured from the surface upon which the food and water bowls rest or are adapted to rest, whether that surface is the interior base surface 2a (which might be raised by an elevated interior base surface 2a as shown in FIG. 24) or a filtering tray 30 (as shown in FIG. 9). The high portions of the pet feeding containment system preferably have a height of between about 50% to about 80% of the shoulder height or withers of the pets for which the system is adapted for use. This relative height provides a close proximity between the high portions of the containment system 10 and the head and shoulders of the pet while the pet is feeding. In a preferred embodiment, the high portions have a height that is about 1½ times to about 4 times the height of the low portion, or more preferably about 2 times to about 3½ times the height of the low portion.

Preferably, when the pet reaches into the interior space 3 to access food and water bowls, the high portions of the containment system 10 surround the pet's head and shoulders to create a sense of enclosure. The walls of the containment system 10 provide a physical barrier that deters a pet from moving its head around while feeding. Because the high portions restrict the range of movement of the pet's head, it is believed that a pet will be more likely to keep its head, and therefore spilled food, over the interior base surface 2a of the containment system 10. Therefore, the high portions, and their proximity to the low portion are likely to reduce the chance of the pet bringing its head outside of the containment system 10 and dropping food or water on the floor.

The high portions of the containment system 10 also block the pet's vision, thus obstructing the pet's view of the surrounding area and reducing visual distractions that may cause the pet to move its head or leave the feeding area. The walls also create a physical barrier that inhibits pests, animals, and people, including children, from approaching the feeding bowls. Thus, the walls may hinder pests, such as ants, from accessing the food and water bowls, and also may provide a safety benefit in the case of a small child or other person approaching a feeding dog. Moreover, the system can be easily designed to contain a spill of the entire contents of either or both of the food and water bowls, unlike certain prior art systems.

To identify how much of the overall wall should be the low portion versus the high portion, it is helpful to envision a “best fit” circle to the pet feeding containment system 10. With regard to the “best fit” circle, the low portion does not include the portions of wall between the low portion and the high portions that rise up from the low portion. Preferably, in relation to the “best fit” circle, the low portion of the pet feeding containment system 10 circumferentially occupies from about 85 degrees of the walls to about 40 degrees of the walls. More preferably, the low portion of the pet feeding containment system 10 circumferentially occupies from about 80 degrees of the walls to about 50 degrees of the walls. For example, if the shape of the pet feeding containment system 10 is a square, the low portion can be the majority of the front wall. As another example, in a circular embodiment of the invention, the low portion can be the majority of the front quadrant of the circle. In any embodiment, at least a portion of the front section 12 comprises a high portion. The front section of the pet feeding containment system according to the invention is the entire side of the system which has the low portion. For example, in the substantially rectangular embodiment shown in FIG. 1 or in any of the flattened oval embodiments, the front section 12 comprises the entire front side of a “best fit” rectangle to the containment system 10.

The dimensions of the various features of the pet feeding containment system 10 can vary over wide ranges and are primarily based on the type and breed of the pets for which the system is intended for use. For example, it can be imagined that a system for a large breed of dog would have significantly different proportions from a system for a cat or small dog. The ranges in the following paragraphs are intended to cover the lower limit of a system for various small pet breeds up to an upper limit for a system of a large pet. Of course, a larger version can be used for other animals, as needed.

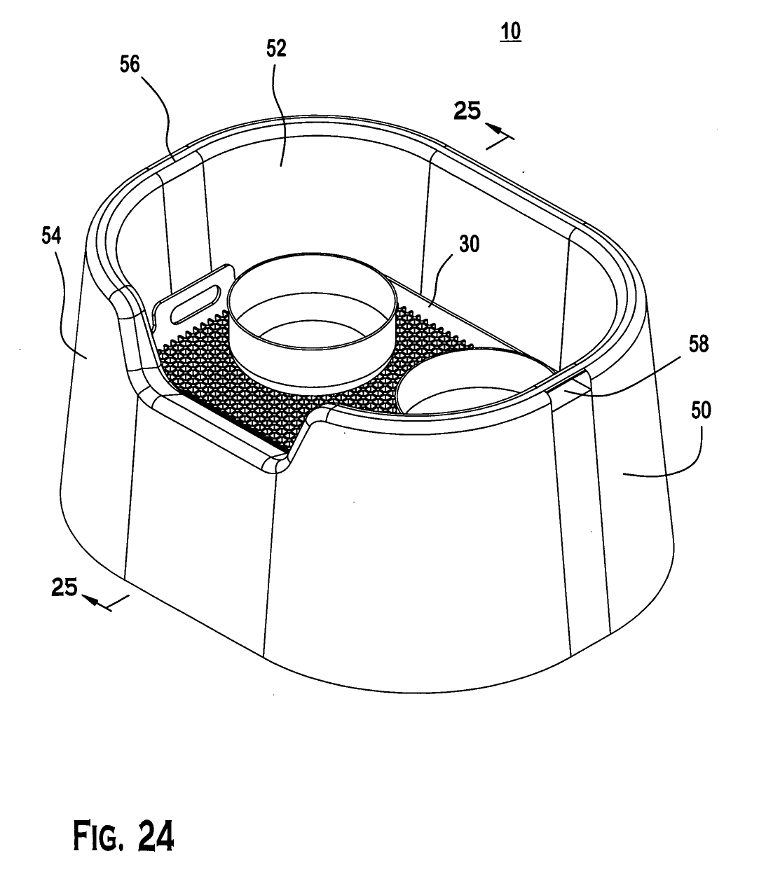

In alternative embodiments of the present invention, elevating means increase the height of the feeding bowls relative to the floor. Such elevating means can elevate the bowls themselves or elevate the surface upon which the feeding bowls rest or are adapted to rest, whether that surface is the interior base surface 2a or a filtering tray 30. Elevating components are alternatively situated within the interior space 3 or outside of the interior space 3. For example, in an embodiment illustrated in FIG. 23, a filtering tray 30 adapted to hold feeding bowls is elevated above the interior base surface 2a and rests upon protruding mounts 21 which extend from the walls. In a preferred embodiment, as illustrated in FIGS. 24 and 25, the interior base surface 2a is raised above the floor. This design is achieved by providing an outer wall 54 which has a greater height as measured from the floor than the height of the inner wall 52 as measured from the interior base surface 2a. Alternative embodiments having elevating components outside of the interior space 3 are contemplated as having legs or support stands, among others. An additional way to provide elevating means is illustrated in FIG. 18, in which the height of the bottom of the mold 68 is raised so that the removable bowl 70 is elevated. For example, this design can be achieved by configuring the relative lengths of the outer and inner walls of the mold 68 appropriately.

It should be noted again that in the following preferred dimensions, the height of the high portions is measured from the floor upon which the containment system 10 rests, and the height of the low portion is measured from the surface upon which the feeding bowls rest or are adapted to rest, whether that surface is the interior base surface 2a or a filtering tray 30. The height of the high portions is preferably in a range of about 6 inches to about 26 inches. It should be recognized that this range contemplates a small embodiment of the present invention (e.g. about 6 inches), and a large embodiment of the present invention (e.g. about 26 inches). The low portion of the front section 12 preferably has a length in a range of about 6 inches to about 22 inches. This range also contemplates a small embodiment of the present invention (e.g. about 6 inches), and a large embodiment of the present invention (e.g. about 22 inches). In different embodiments, the portions of wall between the low portion and the high portions can be a 90 degree step or can be inclined (and such portions are also part of the “high portions” as used herein). Preferably, referring to the paragraph above, the portions of wall between the low portion and the high portions begin to rise from the low portion at no more than 85 degrees of the circumference of the “best fit” circle. The low portion of the front section 12 preferably has a height in a range of about 2 inches to about 10 inches, with the proviso that the absolute height of the high portion be greater than the absolute height of the low portion, i.e. absolute height being measured from the floor upon which the system rests. This range also contemplates a small embodiment of the present invention (e.g. about 2 inches), and a large embodiment of the present invention (e.g. about 10 inches).

Table 1 below provides the approximate ranges of dimensions for small, medium, and large exemplary embodiments of the present invention. The various dimensions indicated in Table 1 are intended to accommodate various cat and dog breed sizes. The heights of the high portions are based on the height of the shoulders or withers of common breeds, as previously mentioned. For example, it is contemplated that a small embodiment of the invention preferably accommodates breeds such as Beagles, Jack Russells, Pugs, Lhasa Apsos, West Highland White Terriers, and some cat breeds; a medium embodiment of the invention preferably accommodates breeds such as Boxers, Collies, Labrador Retrievers, Huskies, and English Setters; and a large embodiment of the invention preferably accommodates breeds such as Akitas, Rottweilers, and Saint Bernards. An extra small version of an embodiment of the present invention, which is not shown in Table 1, is contemplated for certain cat breeds and puppies. Reference in this table is primarily made to dog breeds because of the great variation of sizes within dog breeds; however, the system is clearly intended for use by cats and other animals, and, of course, could be configured in a variety of sizes, as needed.

TABLE 1
Approximate Dimensions of Exemplary Embodiments

| | Height of | | | | | | |
|---|---|---|---|---|---|---|---|
| | High | | Length of | | | | |
| | Portions | Height | Low Portion: | Shoulder | | Base | Top Opening |
| Unit | Above | of Low | Top (T) and | Height of | | Length × Width | Length × Width |
| Size | Floor | Portion* | Bottom (B) | Pet | Sample Breeds | (inches) | (inches) |
| Small | 9 inches | 3 inches | T 12 inches | 11-15 | Beagle, Jack Russell, Pug, Lhasa | 14 × 9 | 15 × 9 |
| | | | B 10 inches | inches | Apso, West Highland Terrier, Cats | | |
| Medium | 12 inches | 5 inches | T 15 inches | 17-23 | Boxer, Collie, Labrador Retriever, | 18 × 12 | 19 × 13 |
| | | | B 13 inches | inches | Husky, English Setter | | |
| Large | 17 inches | 7 inches | T 19 inches | 24-32 | Akita, Rottweiler, Saint Bernard | 25 × 14 | 26 × 16 |
| | | | B 17 inches | inches | | | |

*The height of the low portion is measured from the surface upon which the feeding bowls rest or are adapted to rest.

FIG. 2 is a top plan view of the embodiment illustrated in FIG. 1. Preferably, there are two feeding bowls above the base 2 (having an interior base surface 2a), namely a food bowl 20 and a water bowl 22. The exposed area of the interior base surface 2a surrounding the feeding bowls catches much of the food and water that is dropped by the pet, so that the food and water are not dropped onto the surrounding floors.

It should be further noted that, in addition to containing food that is dropped by a pet while feeding, the walls 4, 6, 8, 12 and base 2 of the containment system 10 substantially contain spills that occur when the system or bowls are knocked into or bumped by a pet or owner. For example, the containment system 10 substantially contains large spills resulting from food or water bowls being overturned and all of the contents being spilled out. It is intended that food and water splash against the walls 4, 6, 8, 12 and run onto the interior base surface 2a or liner 40 (as shown in FIG. 10), thus staying inside the containment system 10. The walls 4, 6, 8, 12 and base 2 also contain spills that are caused by an owner when contents fall out of the bowls as they are being placed inside the system. In addition, the walls 4, 6, 8, 12 inhibit a pet from stepping onto the interior base surface 2a or liner 40, so that spilled matter laying on the interior base surface 2a is prevented from adhering to the pet's paws or feet and being tracked around the house.

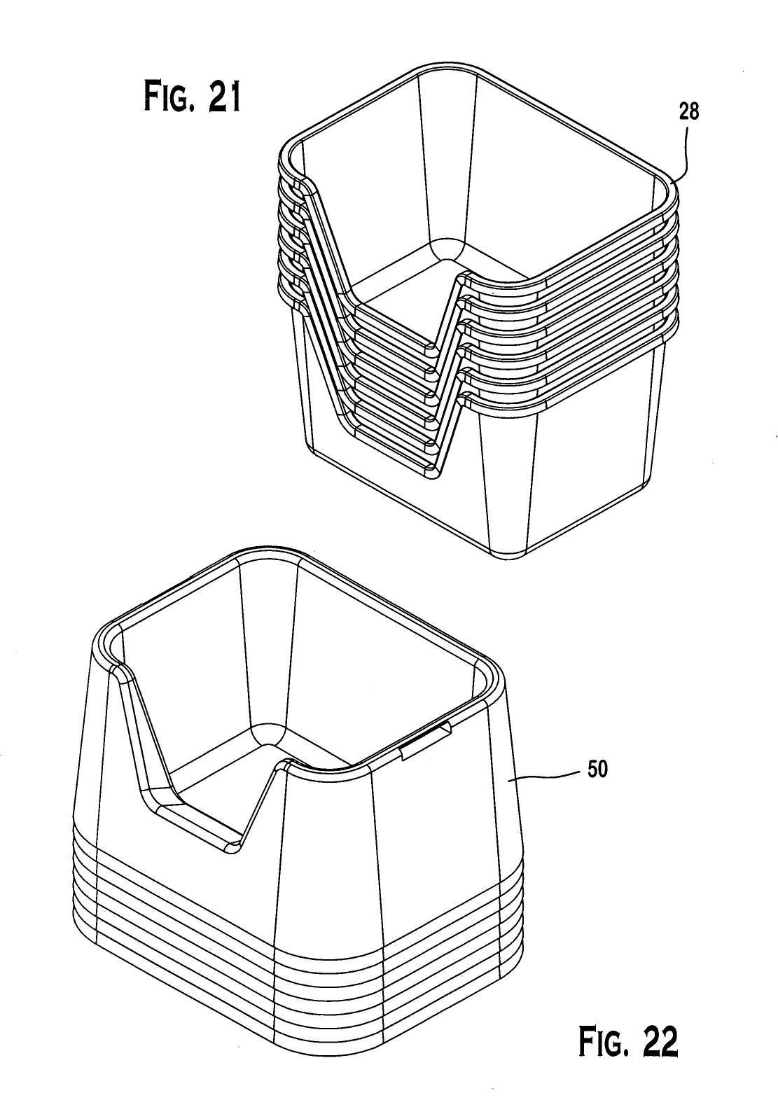

FIG. 3 is a cross-sectional view of the embodiment illustrated in FIGS. 1 and 2. As will be noted from the cross-sectional details of this embodiment, spilled food 24 and spilled water 26 collect on the interior base surface 2a of the containment system 10. Also shown in FIG. 3 is a rolled edge 28 that curves outwardly from the four walls. The rolled edge 28 is a feature that is contemplated in various embodiments of the invention. The rolled edge 28 deters pests from entering the interior space 3, and also provides a handle for the owner. Embodiments of the invention having the rolled edge 28 are preferably stackable. FIG. 21 is a perspective view of several containment systems, having the rolled edge 28, stacked on top of each other.

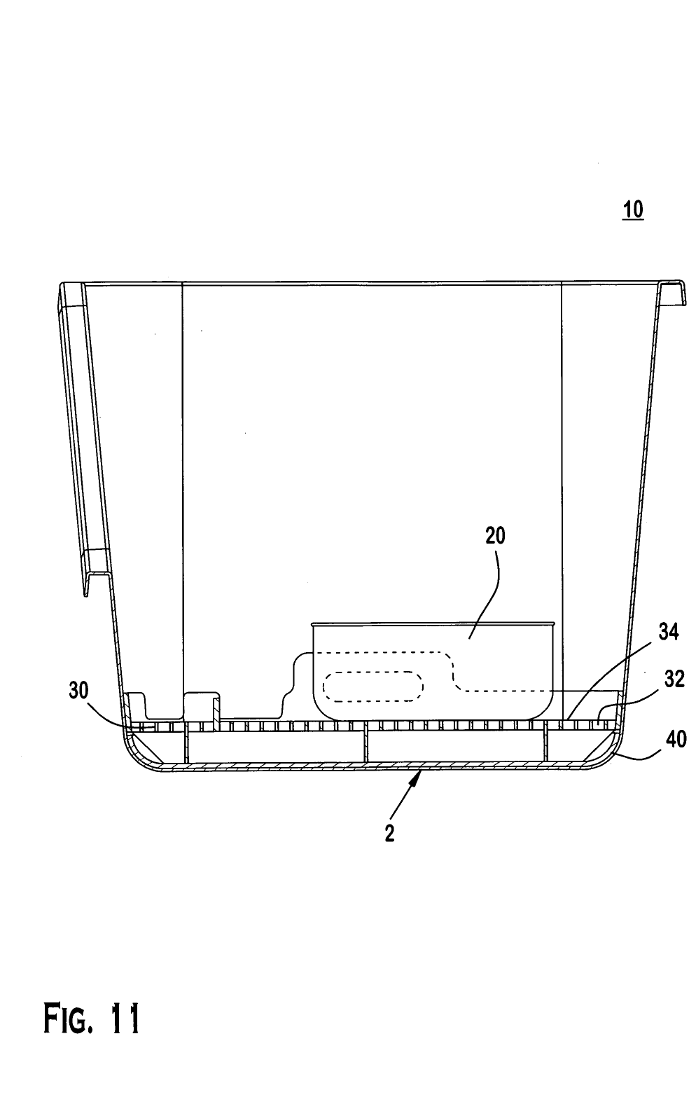

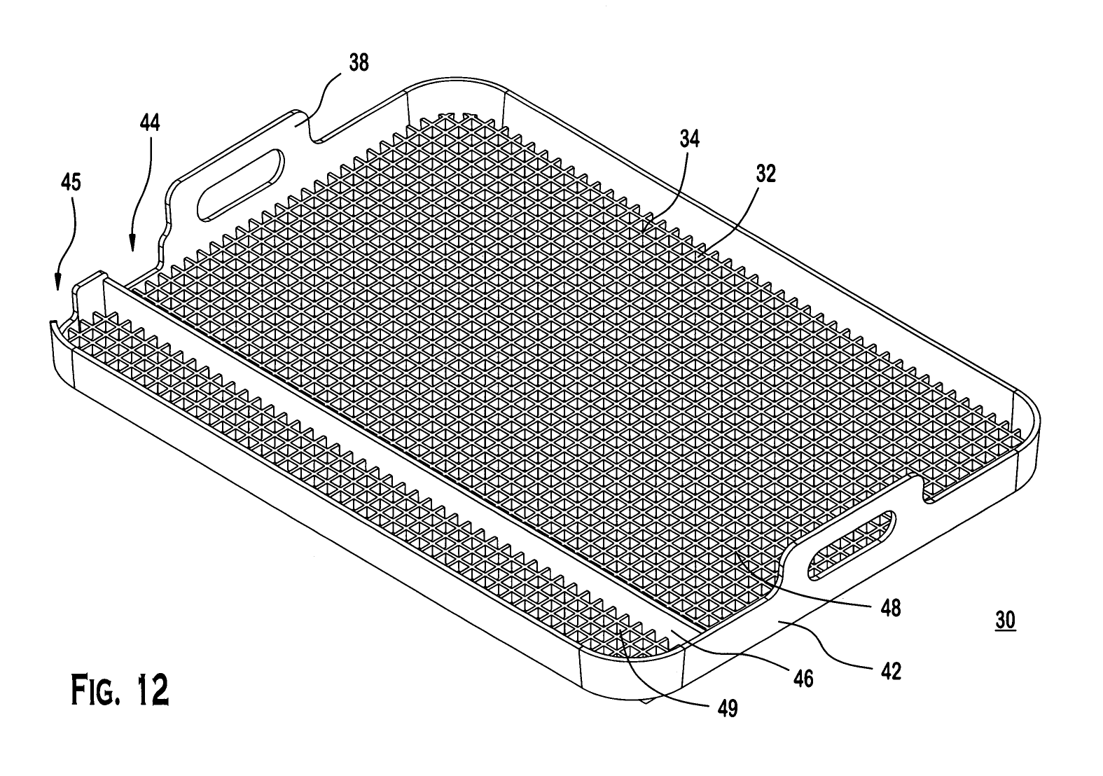

FIG. 6 is a perspective view of another embodiment of the present invention. In this embodiment, the containment system 10 has a filtering tray 30 defining interstitial spaces 32. The filtering tray 30 is disposed above the interior base surface 2a and abuts the four walls, preferably fitting snugly within the containment system 10. According to a preferred embodiment, there are two bowls, namely a food bowl 20 and a water bowl 22, resting on top of the filtering tray 30. In another preferred embodiment, the feeding bowls include engaging means, such as protrusions, that substantially fit into the interstitial spaces 32 of the filtering tray 30 so that the bowls are inhibited from shifting around on the filtering tray. As will be appreciated from FIG. 9, which is a cross-sectional view of the FIG. 6 embodiment, the interstitial spaces 32 are sufficiently small to retain spilled food 24 on top of the filtering tray 30 but allow spilled water 26 to pass through the interstitial spaces 32 onto the interior base surface 2a or liner 40 (shown in FIG. 11). The filtering tray 30 thus separates spilled food 24 from spilled water 26, and prevents spilled water 26 from soaking spilled food 24.

FIG. 12 is a top perspective view of an embodiment of the filtering tray 30. It is contemplated that the filtering tray 30 comprises mesh, wire, or any material having a sufficient number of perforations to keep spilled food separate from spilled water. Most preferably, the filtering tray comprises a screen or plurality of cross bars 34 attached together at their junctures. The interstitial spaces 32 preferably have a width in a range of about 1/16 inch to about ¼ inch. As can be appreciated, the width of the interstitial spaces 32 will depend on the typical size of food pieces used for the type and breed of pet for which the system is intended for use. One benefit of separating spilled food 24 from spilled water 26 is that an owner avoids the messy task of cleaning up soggy and sometimes hardened food. An additional benefit is that an owner is able to collect spilled food 24 from the top of the filtering tray 30. The collected dry food can then be re-used, thus saving the expense of buying additional pet food.

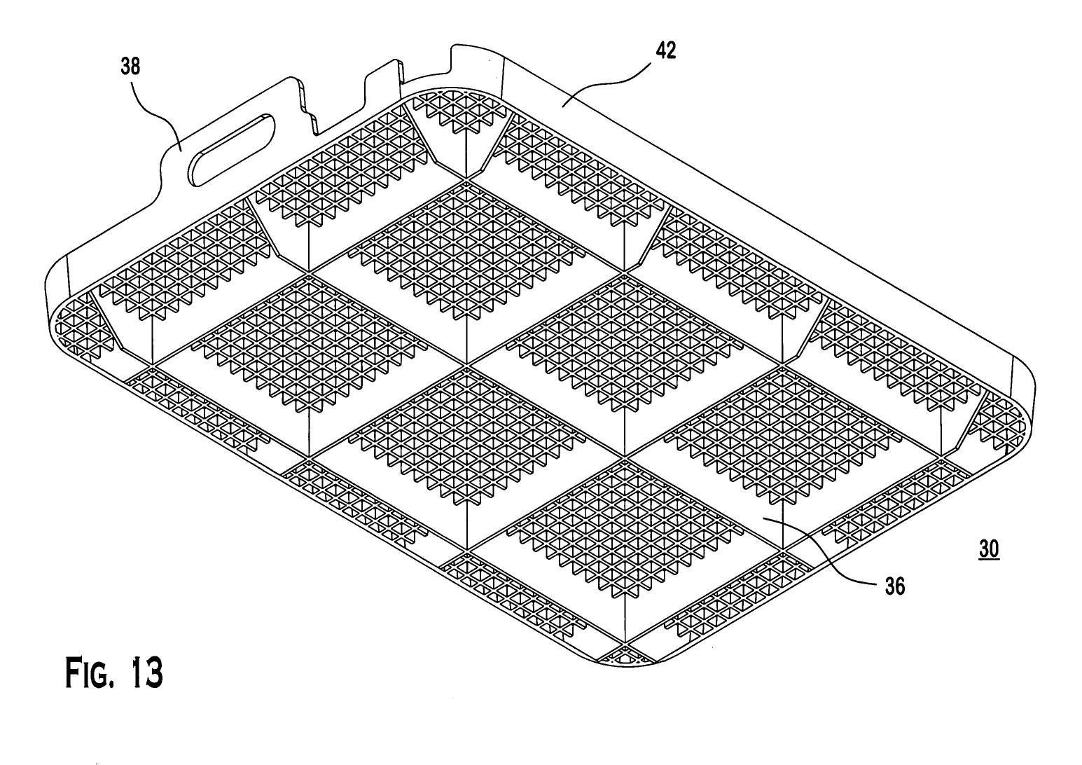

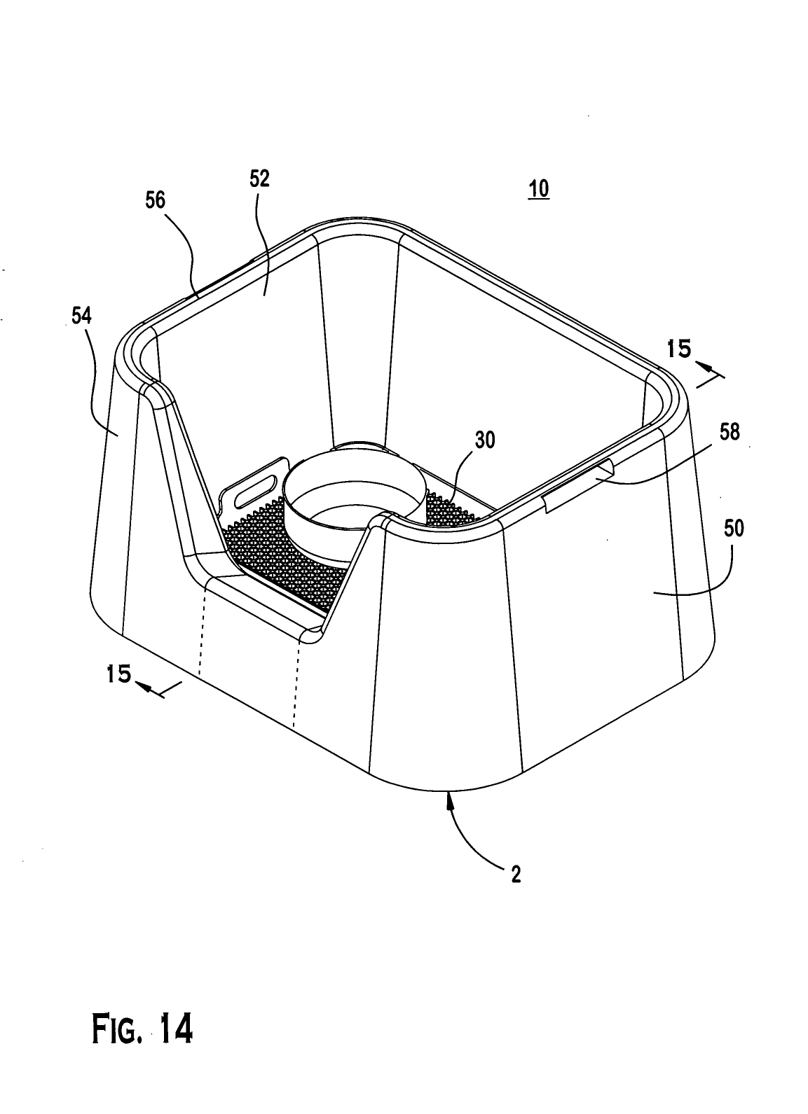

FIG. 13 is a bottom perspective view of the filtering tray 30. The filtering tray 30 is configured to allow for its top surface to be sufficiently high above the interior base surface 2a to keep spilled food separate from spilled water. The filtering tray 30 is preferably disposed in a range of about ½ inch to about 4 inches above the interior base surface 2a to achieve this purpose. Various designs, such as legs or supports, or more preferably raised cross bars 36 that intersect to create a grid, would allow for the top surface of the filtering tray 30 to be sufficiently high above the interior base surface 2a to keep spilled food separate from spilled water. As previously discussed, and as shown in the embodiment illustrated in FIG. 23, in which an elevated filtering tray 30 serves as the means for elevating the height of the feeding bowls, the filtering tray 30 may also be disposed at a greater height above the interior base surface 2a than the range described above in this paragraph, for example about 1 inch to about 14 inches above the interior base surface 2a. The filtering tray 30 is preferably removable and comprises handles 38. It is contemplated that the handles 38 enable an owner to remove the filtering tray 30 to more easily retrieve spilled food 24 from the top of the filtering tray 30 and clean spilled water 26 off of the interior base surface 2a or liner 40.

As illustrated by the exploded view of FIG. 10 and the cross-sectional view of FIG. 11, an additional preferred feature that is contemplated in various embodiments of the invention is a removable liner 40 that rests on the interior base surface 2a. The liner 40 is removable and preferably fits snugly within the containment system 10. The removable liner 40 enables an owner to clean messes off of the liner 40 after it has been removed, rather than performing the more cumbersome task of cleaning the interior base surface 2a of the system. For example, it is contemplated that the liner 40 can be cleaned in a sink or laundry tub, whereas some embodiments of the entire containment system 10 are likely too large to be placed in a sink or laundry tub. The liner 40 preferably includes handles 41. The liner 40 either comprises a separate feature that is removable by itself, or is alternatively removably attached to the filtering tray, so that the liner 40 is removed together with the filtering tray 30, but can be separated therefrom for cleaning.

As illustrated in the embodiment shown in FIG. 12, the filtering tray 30 preferably comprises a peripheral wall 42. The peripheral wall 42 extends upwardly from the periphery of the filtering tray 30 to a height of at least ¼ inch above the filtering tray 30, more preferably to a height of about ½ inch to about 1½ inches above the filtering tray 30. The peripheral wall 42 inhibits spilled food from falling off an edge of the filtering tray 30 onto the interior base surface 2a or liner 40. In a preferred embodiment, the filtering tray 30 further comprises a raised divider 46. The raised divider 46 is substantially parallel to the front section 12 of the containment system 10 when the filtering tray 30 is abutting the walls of the system. The raised divider 46 extends upwardly from the filtering tray 30 to a height of at least ¼ inch above the filtering tray 30, more preferably to a height of about ½ inch to about 1½ inches above the filtering tray 30.

As illustrated in the top plan view of FIG. 8, when set inside the containment system 10, the raised divider 46 is a sufficient distance from the front section 12 to inhibit the food bowl 20 and water bowl 22 from touching the front section 12, most preferably in a range of about 1 inches to about 6 inches from the front section 12. The raised divider 46 inhibits the bowls 20, 22 from sliding forward, and from being pulled forward, on the filtering tray 30 and coming into contact with the front section 12. This further inhibits spills or splashes from soiling the front section 12 of the containment system 10 and the surrounding floor. Thus, spills coming out of the bowls 20, 22 are contained behind the divider 46 on a back portion 48 of the filtering tray 30. Some spilled food and water dropped by the pet may also fall onto a front portion 49 of the filtering tray 30 between the raised divider 46 and the front section 12.

In addition, the peripheral wall 42 alternatively defines at least one gap, more preferably a first gap 44 and a second gap 45. For example, as illustrated in FIG. 12, the first gap 44 is behind the divider 46 on the back portion 48 of the filtering tray 30, and the second gap 45 is in front of the divider 46 on the front portion 49 of the filtering tray 30. In an exemplary embodiment, the filtering tray 30 is removed from the containment system 10, and spilled food is collected from the top of the filtering tray 30 by tipping the filtering tray 30 at an angle to direct the spilled food along the peripheral wall 42 and the raised divider 46 towards the gaps 44, 45 and pouring the spilled food off of the filtering tray 30 through the gaps 44, 45.

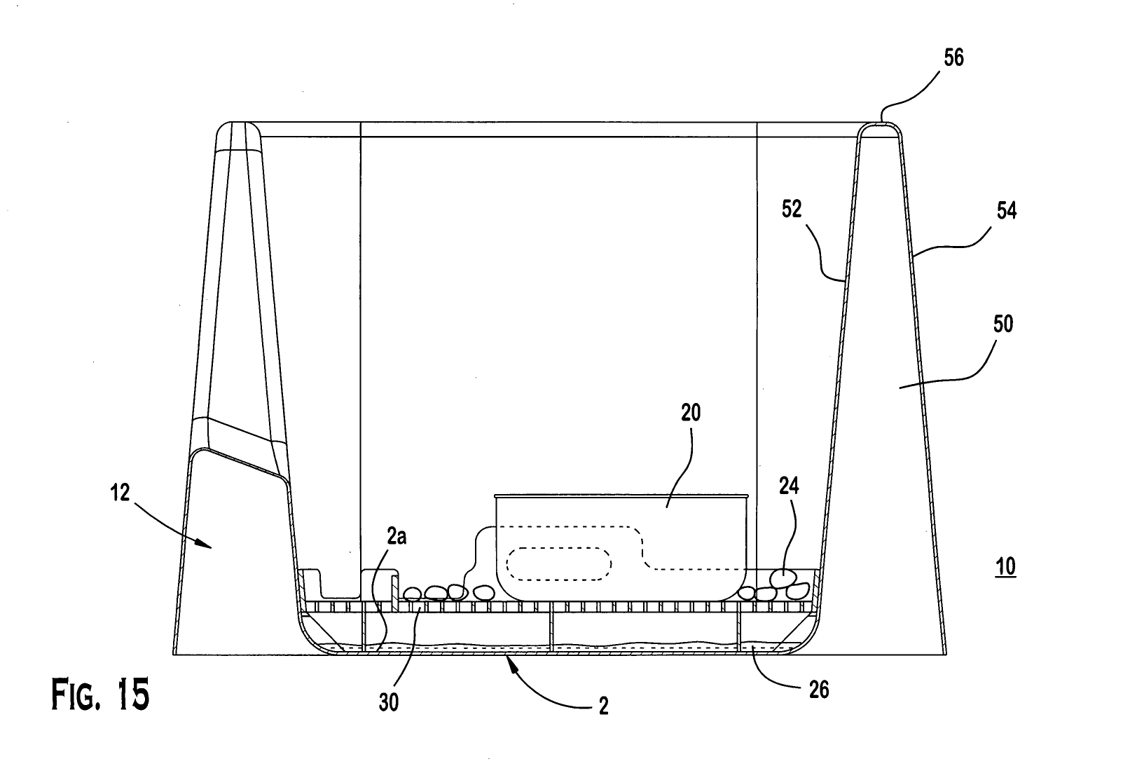

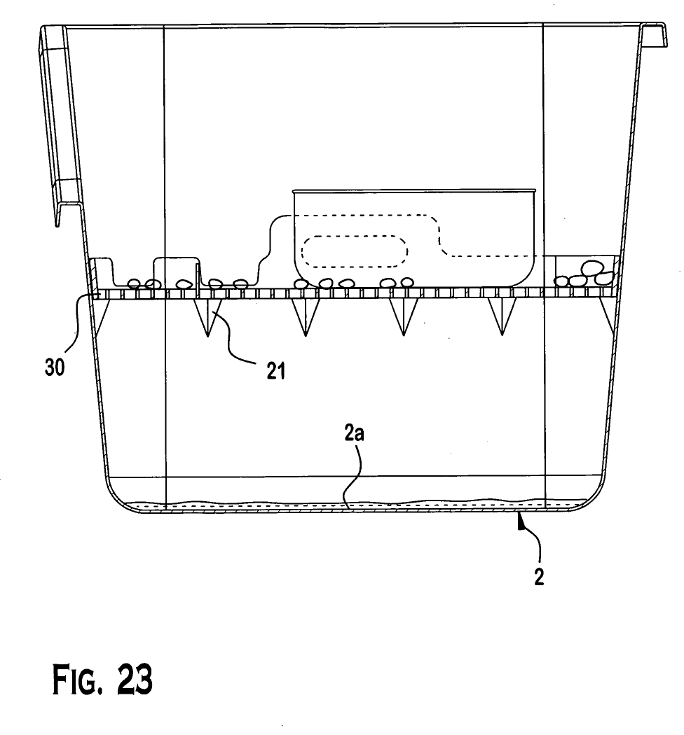

FIG. 14 is a perspective view of another embodiment of the invention. A feature of the invention which is contemplated in alternative embodiments is a double wall 50. As shown in FIG. 14, and in a cross-sectional view in FIG. 15, the walls comprise an inner wall 52, an outer wall 54, and an upper portion 56. The inner wall 52, upper wall 54, and upper portion 56 define a hollow space and essentially form a double wall 50. The double-walled feature further comprises handles 58 so that the owner can more easily lift the containment system 10. The double wall 50 also allows for stackability, as shown in FIG. 22, and may be considered more aesthetically pleasing.

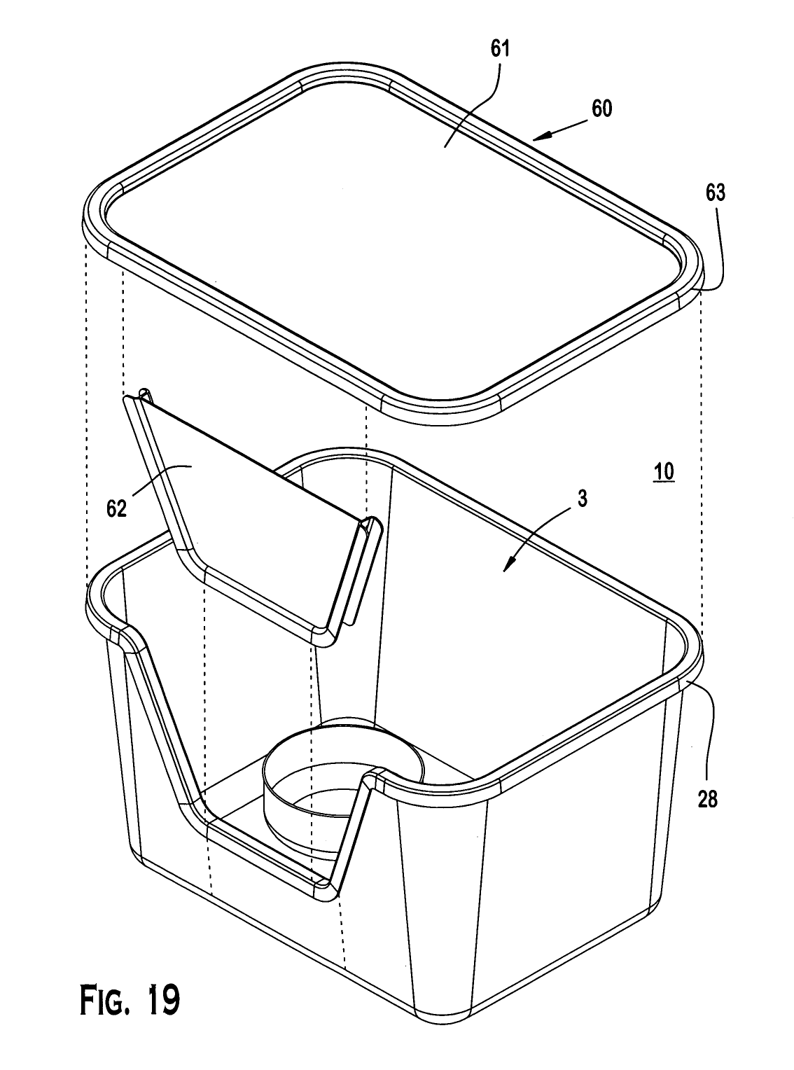

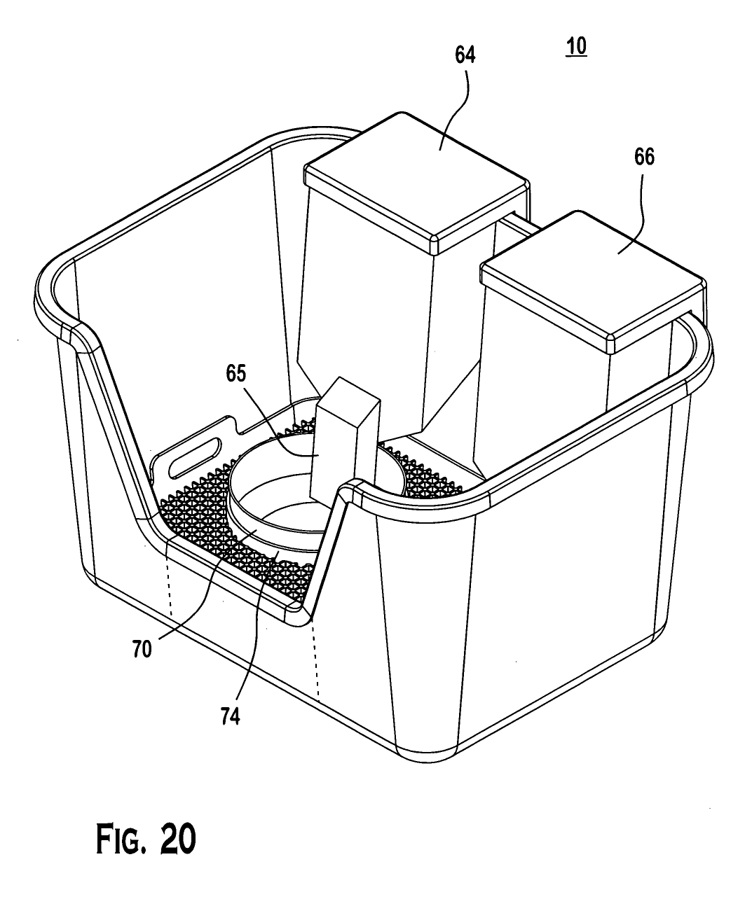

FIG. 19 is an exploded view of an embodiment having a removable lid 60. The removable lid 60 is another feature of the invention that is contemplated in various embodiments of the present invention. The lid 60 enables an owner to close the pet feeding containment system 10 when it is not being used by a pet, thus inhibiting access to the interior space 3 by, for example, pets and children. In the embodiment shown in FIG. 19, there is a top portion 61 for covering the top of the system, and a side portion 62 for covering the space above the lower portion. The lid 60 is contemplated as having either one portion or multiple portions, and as covering either the entire interior space 3, or a portion of the interior space 3. The lid 60 alternatively includes edges 63 that fit together with an embodiment of the invention having the rolled edge 28, thus providing a close-fitting seal. The lid 60 is also contemplated as having edges that fit with features of other embodiments, such as the double wall 50 described above.

FIG. 20 is a perspective view of an embodiment of the invention. A food container 64 and a water container 66 disposed above the food bowl 20 and water bowl 22 are features which are contemplated in various embodiments of the invention. Food is gravity-fed from the food container 64 into the food bowl 20, and water is gravity-fed from the water container 66 into the water bowl 22. Any known food and water containers can be used in the present invention, such as timer-controlled systems. The food container 64 preferably has a chute 65 which extends from the food container 64 into the interior of the food bowl 20. When the level of food becomes lower than the chute opening, food is gravity-fed from the food container 64 into the food bowl 20 and up to the level of the opening of the chute 65. The food and water containers 64, 66 enable a pet owner to pre-fill the containers with food and water so that predetermined levels of food and water are maintained in the bowls. This allows the pet to be continually fed and watered if the owner is unable to provide food and water at a particular feeding time.

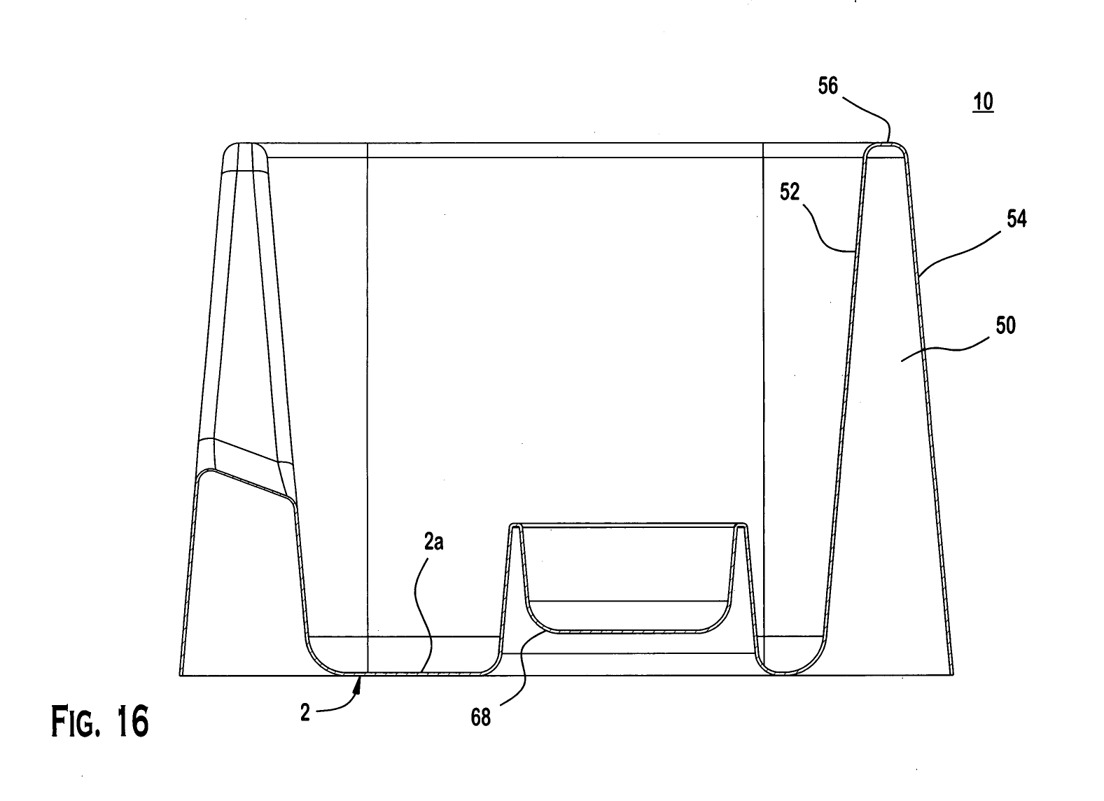

FIG. 16 is a cross-sectional view of an alternative embodiment of the invention. The base 2 defines at least one mold 68 that is adapted to receive at least one removable bowl 70 (as shown in FIG. 18). This molded bowl feature is contemplated in various embodiments of the invention. Preferably, the base 2 defines a first mold for receiving a food bowl and a second mold for receiving a water bowl. In this embodiment, the pet feeding containment system 10, along with the molded bowls, comprises a single monolithic unit (i.e., formed as one component). The molds are preferably hollow underneath for stackability. The removable bowls are contemplated as being washable for repeated use or disposable after each use. Each removable bowl 70 preferably fits snugly within each respective mold 68. The molds are located on the base 2 in a position that is relative to the low portion of the front section 12, so that an area of the interior base surface 2a is exposed between the molds and the low portion. Preferably, the area of the interior base surface 2a exposed is sufficiently large so that food or water dropped by the pet lands on the exposed area of the interior base surface 2a. Most preferably, the length of the area of the interior base surface 2a exposed between the molds and the front section 12 is in a range of about 1 inch to about 6 inches, again depending on the type and breed of pet.

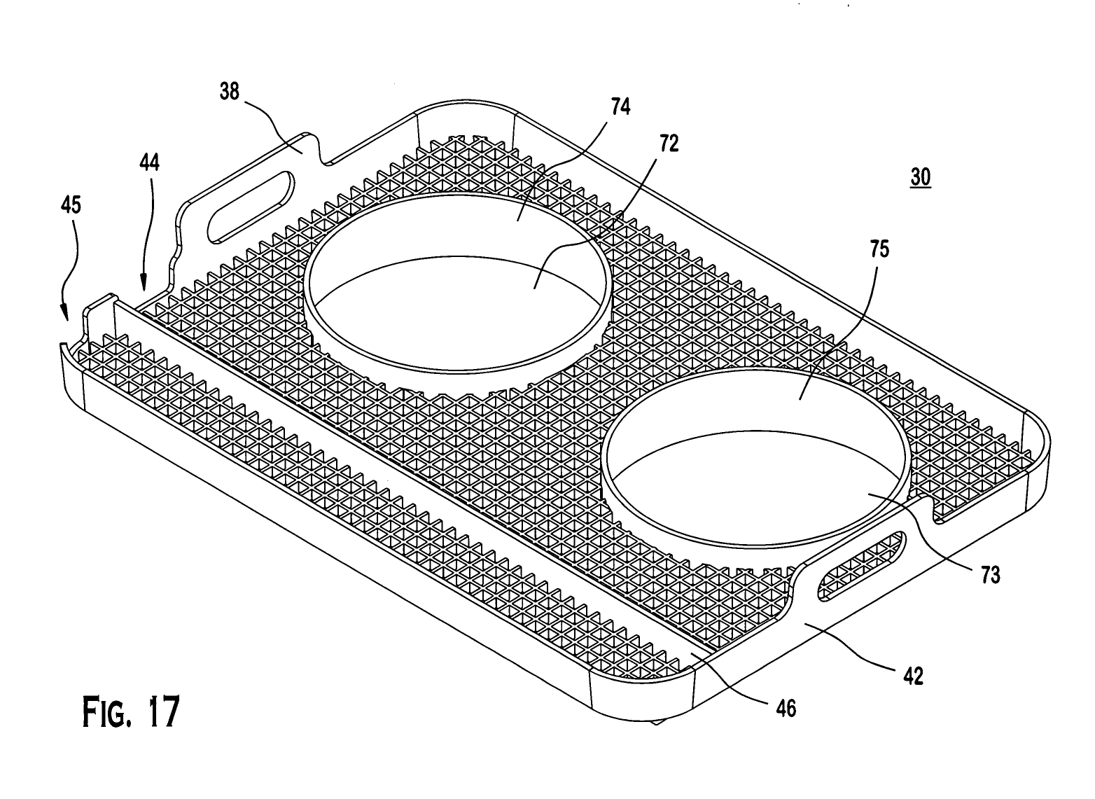

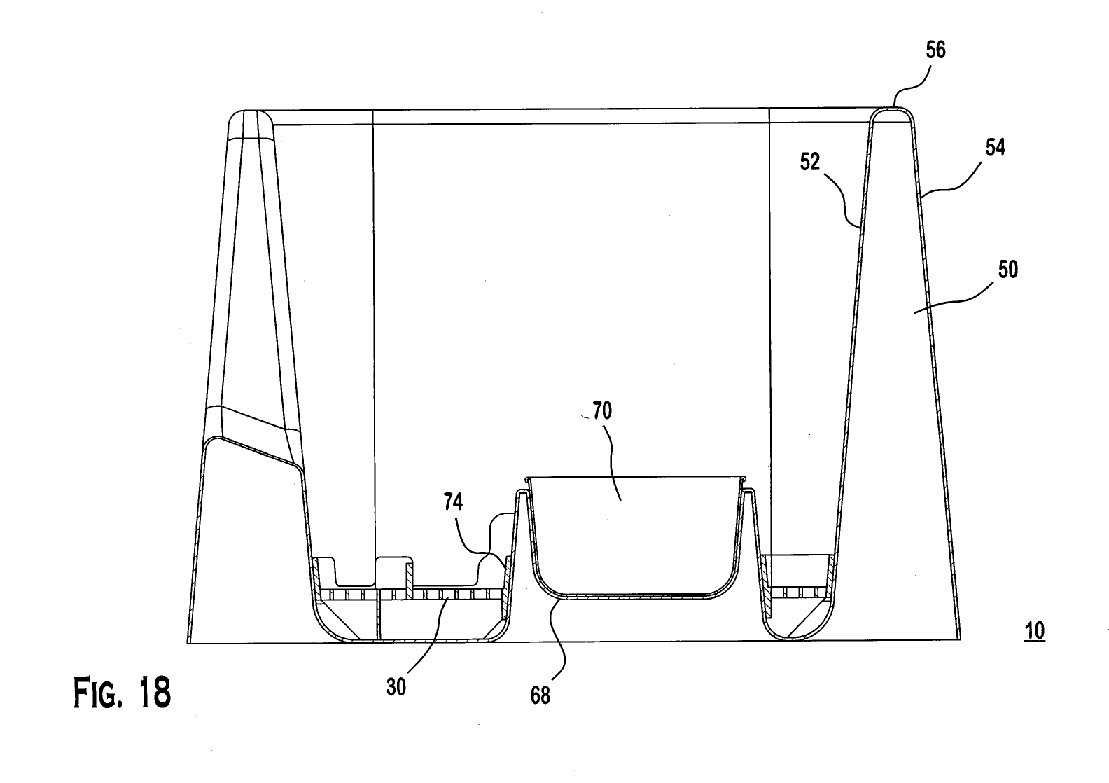

FIG. 18 is a cross-sectional view of an embodiment of the invention in which the monolithic unit includes a filtering tray 30 abutting the molds. FIG. 17 is a perspective view of an embodiment of a filtering tray 30 that would fit around the molds in the base 2. The filtering tray 30 in this alternative embodiment further defines a first opening 72 and a second opening 73. The first opening 72 fits around the first mold, and the second opening 73 fits around the second mold. Most preferably, each of the openings has a peripheral wall 74, 75 extending upwardly to a height of at least ¼ inch above the filtering tray. It is contemplated that the peripheral walls 74, 75 around the openings create a snug fit for the filtering tray 30 with the molded base 2, and inhibit spilled food from falling between the removable bowls 70 resting in the molds 68 and the filtering tray 30 onto the base 2.

FIG. 23 is a cross-sectional view of an embodiment of the invention in which another means for elevating the surface adapted to hold feeding bowls, as discussed previously in connection with FIG. 13, is shown. In FIG. 23, a filtering tray 30 adapted to hold feeding bowls is elevated above the interior base surface 2a and rests upon protruding mounts 21 which extend from the walls. FIGS. 24 and 25 illustrate a perspective view and a cross-sectional view, respectively, of a preferred embodiment of the invention in which the interior base surface 2a is raised above the floor. This design is achieved by providing an outer wall 54 which has a greater height as measured from the floor than the height of the inner wall 52 as measured from the interior base surface 2a.

Although illustrated and described above with reference to certain specific embodiments, the present invention is nevertheless not intended to be limited to the details shown. Rather, various modifications may be made in the details within the scope and range of equivalents of the claims and without departing from the invention. Therefore, features of the invention illustrated in the figures may be included in varying embodiments of the invention. For example, in an embodiment of the present invention, the containment system 10 has a double wall 50 with the walls forming a modified oval shape; a filtering tray 30 and a liner 40, both having modified oval shapes, abut the walls of the containment system 10; and a food bowl 20 and water bowl 22 rest on top of the filtering tray 30 with a food container 64 and water container 66 disposed above the bowls. As another example, in an embodiment of the present invention, the containment system 10 is circular with a rolled edge 28; the base 2 forms two molds, with each mold having a removable bowl 70; and includes a circular filtering tray 30 having a peripheral wall 42 defining gaps 44, 45, a raised divider 46, and two openings 72, 73 that fit around the molds. As another example of an embodiment of the present invention, the surfaces of the molds 68 upon which the removable bowls rest (as shown, for example, in FIG. 18) have an absolute height that is above the absolute height of the low portion, i.e. absolute height being measured from the floor upon which the system rests; in this embodiment, the dimensions used throughout would still apply, except that the height of the low portion would be measured from the interior base surface 2a from which the molds 68 extend upwardly.

What is claimed:

1. A pet feeding containment system comprising:
a base; and
at least one wall having a front section and a remaining section and extending upwardly from the base to define an interior space;
wherein the front section comprises a low portion and at least one high portion and the remaining section comprises a high portion,
wherein the pet feeding containment system is adapted to hold at least one bowl for containing food and water disposed on or above the base.

2. The pet feeding containment system according to claim 1, wherein the base has a periphery and the at least one wall extends upwardly from the base at the periphery.

3. The pet feeding containment system according to claim 1, wherein the remaining section comprises a rear wall, a first side wall, and a second side wall, and the at least one high portion of the front section comprises a left portion and a right portion.

4. The pet feeding containment system according to claim 3, wherein the left portion is connected to the first side wall and the right portion is connected to the second side wall,
wherein the height of the left portion decreases at a slope of 90 degrees or less from the left portion to the low portion, and
wherein the height of the right portion decreases at a slope of 90 degrees or less from the right portion to the low portion.

5. The pet feeding containment system according to claim 1, wherein the pet feeding containment system rests on a floor, and wherein the at least one high portion has a height in a range of about 6 inches to about 26 inches above the floor.

6. The pet feeding containment system according to claim 5, wherein the at least one high portion has a height of about 50% to about 80% of the shoulder height or withers of the pets for which the system is adapted for use.

7. The pet feeding containment system according to claim 1, wherein the low portion has a height in a range of about 2 inches to about 10 inches above a surface adapted to hold the at least one bowl.

8. The pet feeding containment system according to claim 7 further comprising means for elevating the surface adapted to hold the at least one bowl.

9. The pet feeding containment system according to claim 7, wherein the height of the at least one high portion above the floor is about 1½ times to about 4 times the height of the low portion above the surface adapted to hold the at least one bowl.

10. The pet feeding containment system according to claim 1, wherein the low portion has a length in a range of about 6 inches to about 22 inches.

11. The pet feeding containment system according to claim 1, wherein the low portion occupies a range of about 40 degrees to about 85 degrees of the at least one wall.

12. The pet feeding containment system according to claim 1, wherein: (1) the at least one wall further comprises an inner wall, an outer wall, and an upper portion; and (2) the inner wall, the outer wall, and the upper portion define a hollow space.

13. The pet feeding containment system according to claim 12, wherein the at least one wall further comprises handles.

14. The pet feeding containment system according to claim 1, wherein the at least one wall has rolled edges curving outwardly from the interior space to deter pests from entering the interior space.

15. The pet feeding containment system according to claim 1 further comprising a removable lid for closing the containment system and for inhibiting access to the interior space.

16. The pet feeding containment system according to claim 1 further comprising a filtering tray disposed above the base and abutting the at least one wall, wherein:
(1) the filtering tray is adapted to have at least one bowl resting on or abutting the filtering tray;
(2) the filtering tray defines interstitial spaces; and
(3) the interstitial spaces are sufficiently small such that spilled food is filtered from spilled water, the spilled food remains on top of the filtering tray but the spilled water passes through the interstitial spaces onto the base, thereby allowing for separation of the spilled food from the spilled water.

17. The pet feeding containment system according to claim 1, wherein the pet feeding containment system is in the shape of a modified oval, wherein the at least one wall comprises a flat rear section, two flat side sections, and substantially curved corners, and the remaining section comprises the flat rear section and the flat side sections.

18. A pet feeding containment system comprising:
a base;
at least one bowl for containing food and water disposed on or above the base; and
at least one wall having a front section and a remaining section and extending upwardly from the base to define an interior space;
wherein the front section comprises a low portion and at least one high portion and the remaining section comprises a high portion.

19. The pet feeding containment system according to claim 18, wherein the at least one bowl comprises a first bowl for containing food and a second bowl for containing water.

20. The pet feeding containment system according to claim 19 further comprising a food container disposed on or above the first bowl and a water container disposed on or above the second bowl, wherein food is gravity-fed from the food container into the first bowl and water is gravity-fed from the water container into the second bowl.

21. A pet feeding containment system comprising:
a base; and
at least one wall having a front section and a remaining section and extending upwardly from the base to define an interior space;
wherein the front section comprises a low portion and at least one high portion and the remaining section comprises a high portion,
wherein the base and the at least one wall comprise a single monolithic unit,
wherein the base defines at least one mold adapted to receive at least one removable bowl for containing food or water.

22. The pet feeding containment system according to claim 21, wherein the at least one mold is disposed at a location relative to the front section such that an area of the base is exposed between the at least one mold and the front section.

23. The pet feeding containment system according to claim 22, wherein the area of the base exposed between the at least one mold and the front section is sufficiently large to contain spilled food or water.

24. The pet feeding containment system according to claim 22, wherein the length of the area of the base exposed between the at least one mold and the front section is in a range of about 1 inch to about 6 inches.

25. A pet feeding containment system comprising:
a base;
a filtering tray defining interstitial spaces; and
at least one wall extending upwardly from the base;
wherein the filtering tray is disposed above the base,
wherein the filtering tray is adapted to have at least one bowl for containing food and water resting on or abutting the filtering tray,
wherein the interstitial spaces are sufficiently small to retain spilled food on the filtering tray but allow spilled water to pass through the interstitial spaces onto the base.

26. The pet feeding containment system according to claim 25, wherein the filtering tray is disposed in a range of about ½ inch to about 14 inches above the base.

27. The pet feeding containment system according to claim 25, wherein the filtering tray comprises a screen or a plurality of cross bars attached together at their junctures, and the interstitial spaces have a width in a range of about 1/16 inch to about ¼ inch.

28. The pet feeding containment system according to claim 25, wherein the filtering tray is removable.

29. The pet feeding containment system according to claim 25, wherein: (1) the at least one wall further comprises an inner wall, an outer wall, and an upper portion; and (2) the inner wall, the outer wall, and the upper portion define a hollow space.

30. The pet feeding containment system according to claim 29, wherein the at least one wall further comprises handles.

31. The pet feeding containment system according to claim 25, wherein the at least one wall has rolled edges curving outwardly from the interior space to deter pests from entering the interior space.

32. The pet feeding containment system according to claim 25 further comprising a removable lid for closing the containment system and for inhibiting access to the containment system.

33. The pet feeding containment system according to claim 25, wherein the base has an interior base surface and the system further comprises means for elevating the interior base surface.

34. The pet feeding containment system according to claim 25, wherein the filtering tray further comprises a peripheral wall, wherein the peripheral wall extends upwardly from the filtering tray to a height of at least ¼ inch above the filtering tray.

35. The pet feeding containment system according to claim 34, wherein the peripheral wall defines at least one gap.

36. The pet feeding containment system according to claim 25, wherein the filtering tray further comprises a raised divider, wherein (1) the raised divider is substantially parallel to the front section, (2) the raised divider extends upwardly from the filtering tray to a height of at least ¼ inch above the filtering tray, and (3) the raised divider is in a range of about 1 inches to about 6 inches from the front section.

37. The pet feeding containment system according to claim 25, wherein the filtering tray further comprises two handles.

38. The pet feeding containment system according to claim 25 further comprising a removable liner disposed on or above the base and below the filtering tray.

39. The pet feeding containment system according to claim 25, wherein the base and the at least one wall comprise a single monolithic unit, wherein the base defines at least one mold adapted to receive at least one removable bowl for containing food or water.

40. A pet feeding containment system comprising:
a base;
a filtering tray defining interstitial spaces;
at least one wall extending upwardly from the base; and
at least one bowl for containing food and water resting on or abutting the filtering tray,
wherein the filtering tray is disposed above the base,
wherein the interstitial spaces are sufficiently small to retain spilled food on the filtering tray but allow spilled water to pass through the interstitial spaces onto the base.

41. The pet feeding containment system according to claim 40, wherein the at least one bowl comprises a first bowl for containing food and a second bowl for containing water.

42. The pet feeding containment system according to claim 41 further comprising a food container disposed on or above the first bowl and a water container disposed on or above the second bowl, wherein food is gravity-fed from the food container into the first bowl and water is gravity-fed from the water container into the second bowl.

43. The pet feeding containment system according to claim 41 wherein the filtering tray further defines a first opening and a second opening, wherein the first opening fits around the first bowl and the second opening fits around the second bowl.

44. The pet feeding containment system according to claim 43, wherein the filtering tray has a periphery and further comprises three peripheral walls, wherein the first peripheral wall extends upwardly from the periphery of the filtering tray to a height of at least ¼ inch above the filtering tray,
wherein the first opening has a periphery and the second peripheral wall extends upwardly from the periphery of the first opening to a height of at least ¼ inch above the filtering tray, and
wherein the second opening has a periphery and the third peripheral wall extends upwardly from the periphery of the second opening to a height of at least ¼ inch above the filtering tray.

45. The pet feeding containment system according to claim 40, wherein the at least one bowl further comprises means for engaging the filtering tray.

46. A pet feeding containment system consisting essentially of:
a base;
at least one bowl for containing food and water disposed on or above the base;
at least one wall having a front section and a remaining section and extending upwardly from the base to define an interior space;
wherein the front section comprises a low portion and at least one high portion and the remaining section comprises a high portion.
